(19) United States
(12) Patent Application Publication
(10) Pub. No.: US 2013/0178167 A1
(43) Pub. Date: Jul. 11, 2013

(54) SYSTEM AND METHOD FOR REDUCING SPECIFIC ABSORPTION RATE OF A WIRELESS COMMUNICATIONS DEVICE

(71) Applicants: Ian Lockerbie, Calgary (CA); Kevin Clancy, Calgary (CA)

(72) Inventors: Ian Lockerbie, Calgary (CA); Kevin Clancy, Calgary (CA)

(73) Assignee: Novatel Wireless, Inc., San Diego, CA (US)

(21) Appl. No.: 13/346,413

(22) Filed: Jan. 9, 2012

(51) Int. Cl. H04B 1/40

(52) U.S. Cl. 455/63.4

(57) ABSTRACT

Systems and methods are provided for controlling Specific Absorption Rate (SAR) levels in wireless communications devices that utilize at least two transmit (Tx) antennas. In particular, mechanisms are provided to reduce and/or maintain SAR levels to meet regulatory requirements by at least one of the following: controlling energy transmission based upon orientation of the device; controlling use of Tx antennas such that physically separate Tx antennas are utilized; and coordinating the use of Tx antennas based upon time averaged energy considerations.

### TECHNICAL FIELD

The present application relates generally to portable communications devices, and more particularly, to systems and methods for reducing and/or maintaining specific absorption rate (SAR) levels that are in compliance with regulatory restrictions.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The Federal Communications Commission (FCC) has promulgated changes to rules regarding the regulation of external antenna use in wireless communication devices. In particular, the FCC has expressed growing concern about external antennas and their Specific Absorption Rate (SAR) effects. The FCC previously adopted limits for safe exposure to radiofrequency (RF) energy given in terms of SAR units, a measure of the amount of RF energy absorbed by the body when using a device, such as a mobile phone. For example, the FCC requires mobile phone manufacturers to ensure that their phones comply with these objective limits for safe exposure by operating at or below the desired SAR levels. The FCC has also set forth rules concerning SAR levels of devices that may utilize external antennas, such as Universal Serial Bus (USB) dongles, external and/or embedded modems, etc. Even when body tissue can be moved further away from a radiating source, regulatory requirements still exist when exposure may occur at distances of over 20 cm from body tissue, i.e., maximum permissible exposure (MPE) limits

More recently, the FCC has changed the way that SAR effects are measured with respect to USB stick/dongle communications devices that emit RF energy, such as USB modems with configurations that include, but are not limited to, straight USB sticks, swivel USB sticks, fixed angular USB sticks, etc. Additionally, USB devices such as USB modems may utilize/incorporate more than one transmitting (Tx) antenna, for example, USB modems that provide WiMAX functionality via at least two Tx antennas that may result in increased SAR levels.

In particular, the FCC requires that the SAR level of USB devices must be tested at a separation distance of ≦0.5 cm between the USB device and the human body tissue simulating phantom. Previously, the requisite separation for measuring SAR levels was ≦1.5 cm. The shorter test separation distance presents issues for conventional USB devices (using one and especially multiple antennas), in that such conventional USB devices are unlikely able to pass the updated SAR measurement requirements as set forth by the FCC in OET Bulletin 65 (Supplement C).

### SUMMARY

Various aspects of examples of the invention are set out in the claims. According to a first aspect, a method comprises monitoring operation of a wireless communications device having at least a first antenna and a second antenna. The method further comprises adjusting RF signal transmission activity of the wireless communications device based on first antenna RF signal transmission relative to second antenna RF signal transmission to control at least one of SAR and MPE levels of the wireless communications device.

According to a second aspect, a computer-readable memory includes computer executable instructions, the computer executable instructions, which when executed by a processor, cause an apparatus to: monitor operation of a wireless communications device having at least a first antenna and a second antenna; and adjust RF signal transmission activity of the wireless communications device based on first antenna RF signal transmission relative to second antenna RF signal transmission to control at least one of SAR and MPE levels of the wireless communications device.

According to a third aspect, an apparatus comprises at least one processor and at least one memory. The at least one memory includes computer program code, the at least one memory and the computer program code configured to, with the at least one processor, cause the apparatus to perform at least the following: monitor operation of a wireless communications device having at least a first antenna and a second antenna; and adjust RF signal transmission activity of the wireless communications device based on first antenna RF signal transmission relative to second antenna RF signal transmission to control at least one of SAR and MPE levels of the wireless communications device.

### BRIEF DESCRIPTION OF THE DRAWINGS

For a more complete understanding of example embodiments, reference is now made to the following descriptions taken in connection with the accompanying drawings in which:

FIG. 1 illustrates an exemplary wireless communications device comprising in part, at least two Tx antennas;

FIG. 2 is a schematic representation of exemplary components of a wireless communications device;

FIGS. 3A-3D illustrate exemplary orientations of a USB connector of a wireless communications device;

FIGS. 4A and 4B illustrate exemplary orientations of a wireless communications device relative to a host and human tissue;

FIGS. 5A-5B are graphs illustrating exemplary SAR measurements and resulting peak SAR locations.

FIGS. 6A-6B are graphs illustrating exemplary SAR measurements and resulting peak SAR locations when multiple antennas are simultaneously transmitting;

FIGS. 7A-7B are graphs illustrating exemplary power-time SAR/MPE measurements; and

FIG. 8 is a flow chart illustrating exemplary processes performed in accordance with various embodiments to reduce SAR/MPE levels in a wireless communications device.

### DETAILED DESCRIPTION OF THE DRAWINGS

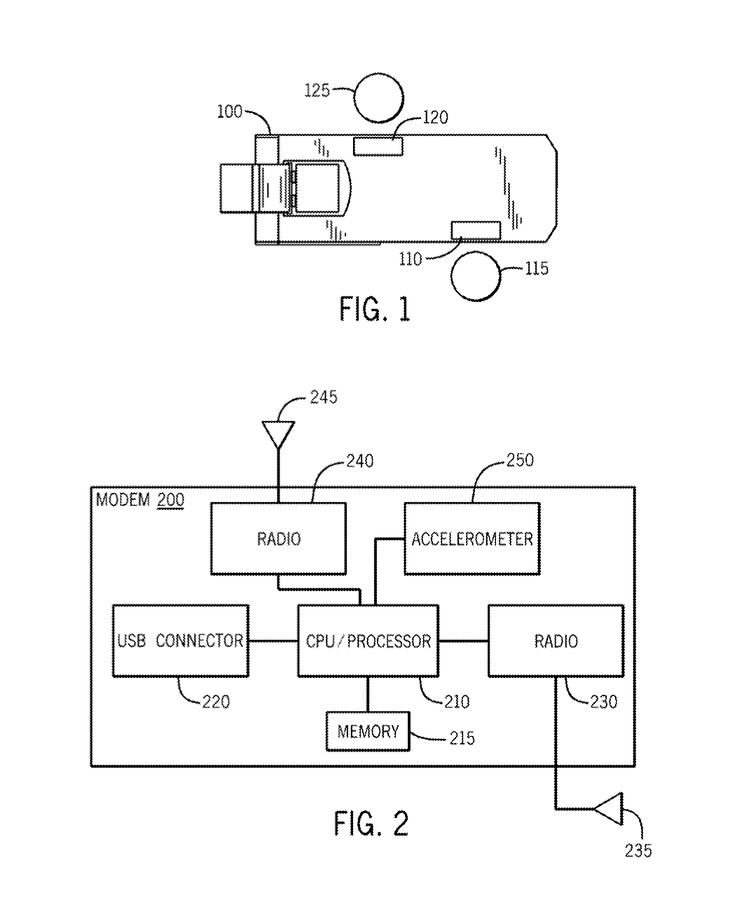

Example embodiments and their potential advantages are understood by referring to FIGS. 1-8 of the drawings.

Various embodiments of the present invention are directed to controlling RF exposure from wireless communications devices that utilize at least two Tx antennas. In particular, various embodiments provide mechanisms to reduce and/or maintain SAR/MPE levels to meet regulatory requirements by at least one of the following: controlling energy transmission based upon orientation of the device; controlling use of Tx antennas such that physically separate Tx antennas are utilized; and coordinating the use of Tx antennas based upon time averaged energy considerations.

FIG. 1 illustrates an exemplary wireless communications device 100 having a first Tx antenna 110 and a second Tx antenna 120. The device 100 may be a USB modem configured for connection to a host device, such as a laptop computer. FIG. 2 illustrates a modem 200, which provides a schematic representation of the device 100 illustrated in FIG. 1. Modem 200 may include at least one central processing unit (CPU)/processor 210 and at least one memory unit 215. Modem 200 may further include a USB connector 220 allowing the modem 200 to be connected to a host device. Moreover, the modem 200 includes at least two radios 230 and 240, each of which comprises a transmitter and receiver. Connected to each of the radios 230 and 240, are antennas 235 and 245, respectively. Further still, the modem 200 may include a sensor 250 for sensing the orientation of the modem 200. Sensor 250 may be any type of sensing equipment/device, such as an accelerometer.

In a device with multiple transmitters/radios, such as device 100, multiple transmit power peaks occur depending on which antenna is active at any given time. For example, device 100 may be a USB stick modem that provides WiMAX functionality via the two Tx antennas 110 and 120. If device 100 is transmitting on Tx antenna 110, a field peak near that antenna results, as shown by field 115. If device 100 is transmitting on Tx antenna 120, a field peak near that antenna results, as shown by field 125.

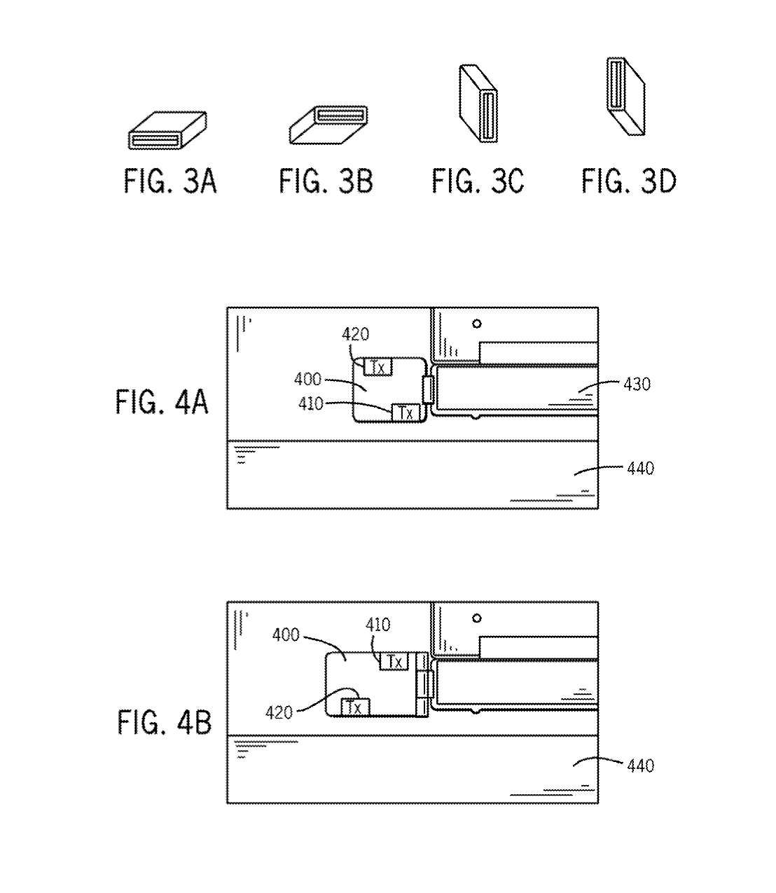

Operating conventionally, device 100 may choose to transmit to either Tx antenna 110 or 120 depending on, e.g., the propagating conditions, to achieve the best signal to noise (S/N) ratio. Four positions generally exist with respect to how the device 100 may be connected to a host device, i.e., how the USB device can be plugged into the host device. These four positions are illustrated in FIGS. 3A-3D, FIGS. 3A and 3B being indicative of alternative “horizontal” orientations, and FIGS. 3C and 3D being indicative of alternative “vertical” orientations.

FIG. 4A is illustrative of a scenario, where a USB device 400 is connected to a host device 430. As previously described, the USB device 400 may utilize at least two Tx antennas 410 and 420. If the USB device 400 is connected to the host device 430 in a vertical orientation such as that illustrated in FIG. 3C, the USB device 400 will be oriented in such a manner that Tx antenna 410 is located proximate to body tissue 440. FIG. 4B is illustrative of another scenario, where the USB device 400 is connected to the host device 430 in another vertical orientation such as that illustrated in FIG. 3D. As a result, the USB device 400 will be oriented in such a manner that Tx antenna 420 is located proximate to body tissue 440. However, if the USB device 400 selects Tx antenna 410 in the scenario illustrated in FIG. 4A or the Tx antenna 420 in the scenario illustrated in FIG. 4B, (based on beneficial propagation conditions), the peak transmit energy in each scenario will be directed towards the body tissue 440, potentially leading to SAR failures (i.e., SAR levels that exceed regulatory requirements).

To avoid potential SAR failures, in accordance with one embodiment of the present invention, an accelerometer is provided in a USB device, such as accelerometer 250 illustrated in FIG. 2. The accelerometer is able to sense/determine an orientation of a USB device. If the orientation of the USB device is one in which a Tx antenna would be transmitting energy towards the direction of body tissue, the transmit energy is confined to one or more alternative Tx antennas that would result in the transmit energy being directed in another way so as to avoid SAR failure. Therefore, RF exposure may be limited to well below the permissible exposure limits regardless of test separation distance requirements. It should be noted that any other type of suitable sensor or determining element may be utilized in accordance with various embodiments to detect the orientation of the USB device.

For example, returning to the scenario illustrated in FIG. 4A, an accelerometer would be utilized to determine that the orientation of the USB device 400 is such that Tx antenna 410 would direct transmit energy towards body tissue. As a result, the USB device 400 inhibits the ability to direct the transmit energy to Tx antenna 410. Instead, the USB device 400 might direct the transmit energy to Tx antenna 420, where a resulting field peak would not be proximate to the body tissue 440. In accordance with various embodiments, while an accelerometer or other suitable sensor is utilized to determine orientation, an algorithm is provided and executed by the CPU/processor of a USB device to actually restrict the ability of the USB device to direct transmit energy to only those Tx antennas that would not lead to potential SAR failures. Any appropriate algorithm or instruction code could be utilized in accordance with various embodiments.

Certain wireless communications devices, such as USB modems that provide multiple modes of connectivity, e.g., EVDO and WiMAX, also utilize multiple Tx antennas. Furthermore, such a USB modem may transmit on more than one Tx antenna at the same time. However, wireless communications devices that support multiple radios and antennas often require that the antennas are in close proximity to each other. In the event that multiple radios are transmitting at the same time, there is a risk that the resulting peak SAR will be high if the antennas are physically close to each other. Conventional devices capable of simultaneous transmissions on multiple antennas are generally larger in size and are not bound by the same SAR requirements that USB dongle devices are subject to. Conventional smaller sized devices often experience difficulty maintaining allowable SAR levels when only a single antenna is active. It is nearly impossible for conventional smaller sized devices to meet SAR requirements when at least two antennas are transmitting at the same time.

SAR measurements in this context may be thought of as being analogous to thermal measurements in the sense that if there is a point thermal source, the point thermal source will create a hot spot. If two thermal sources are brought together, the peak temperature will increase. Likewise, if two active antennas are located in close proximity to each other, the resulting peak SAR will increase.

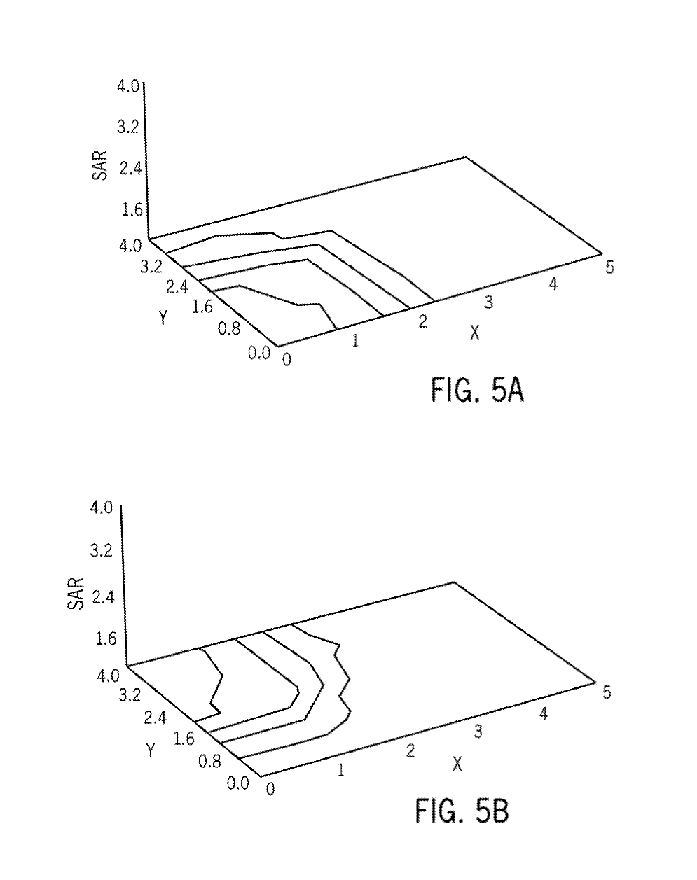

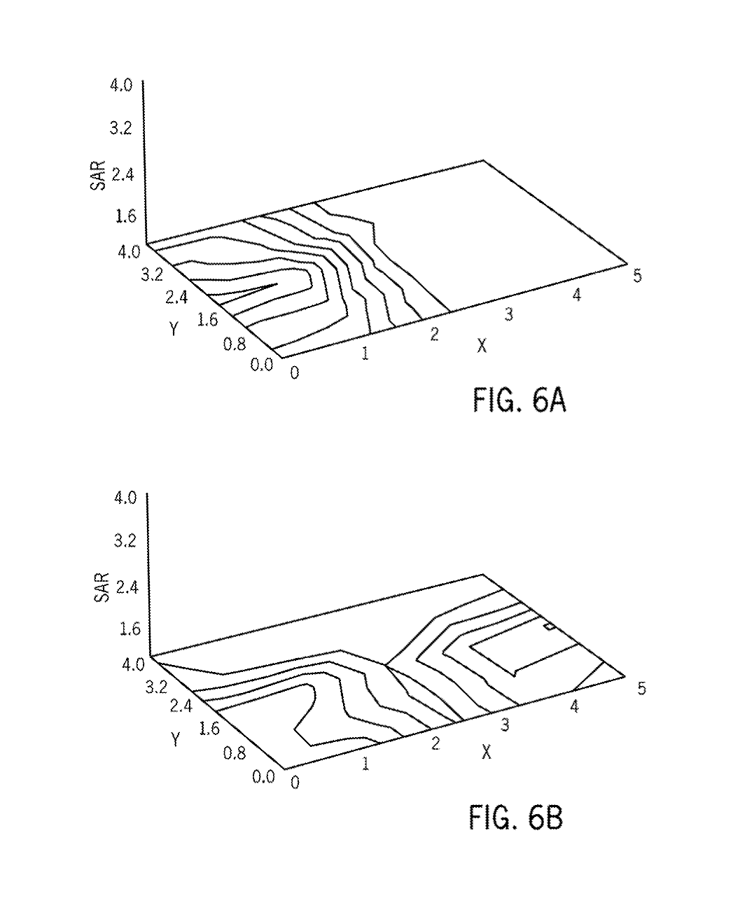

FIG. 5A is a graph illustrating exemplary SAR measurements taken relative to distance in the X and Y planes when, e.g., a single antenna of a first technology, e.g. EVDO, is active. It can be seen that the resulting hot spot (peak SAR) is located at the lower right corner of the graph. FIG. 5B is a graph illustrating exemplary SAR measurements taken relative to distance in the X and Y planes when a single antenna of a second technology, e.g., WiMAX, is active. In this instance, the hot spot is located at the lower left corner of the graph. FIG. 6A is graph illustrating exemplary SAR measurements, taken relative to distance in the X and Y planes when the antennas of the first and second technologies are transmitting simultaneously and are located in close proximity to each other. FIG. 6A clearly shows that the resulting hot spot or peak SAR has increased from the scenarios where only a single antenna is active.

In accordance with another embodiment of the present invention, and when a device has additional antennas it is able to direct transmit energy towards, the device may coordinate Tx antenna usage so that the use of multiple radios/transmitters does not violate any regulated SAR limits. That is, the multiple radios/transmitters can be controlled to use Tx antennas that are physically more separate than Tx antennas that are in close proximity. Ensuring that physically separate Tx antennas are active, allows peak SAR to be reduced. FIG. 6B illustrates a hot spot or peak SAR resulting from the use of physically separate Tx antennas. It can be seen that the peak SAR is considerably less that that generated by simultaneously active Tx antennas that are in close proximity to each other as illustrated in FIG. 6A.

Various methods may be implemented to effectuate the use of physically separate Tx antennas. In accordance with one aspect, the multiple radios of a device may be configured to have a master/slave relationship, where a first radio may have the freedom to select a Tx antenna for its use. A second/additional radio(s) wishing to transmit at the same time must adjust its Tx antenna selection to comply with the requirement that physically separate Tx antennas are used during simultaneous transmissions between the first and second/additional radios.

More elaborate schemes as well as simpler schemes are also contemplated by the present invention. For example, radios may be “weighted,” where one radio may have a more critical transmission than another radio, in which case, preference for Tx antenna selection may be given to that radio having the more critical transmission. As another example, the first radio to begin transmission may have the freedom to select a Tx antenna, and any subsequent radio may be forced to utilize a physically separate Tx antenna. Alternatively still, priority need not be given to any radio, where any radios that are simultaneously active are controlled together to meet the condition that Tx antennas transmitting at the same time are not physically close to one another. Yet another aspect may involve utilizing the transmit power levels of the transmitting radios involved to determine whether a preference to override normal Tx antenna selection criteria should be implemented in order to mitigate SAR effects. It should be noted that various embodiments of the present invention are not limited by the example scenarios presented herein, and that any type of algorithm/selection process may be used as long as the result is that simultaneously transmitting Tx antennas are physically separate to allow a reduction in peak SAR.

As described above, the power levels associated with Tx antennas may be determined/measured and utilized to regulate RF signal transmission of one or more Tx antennas in a wireless communications device, such as a USB modem, to mitigate SAR effects. In addition to being a measure of energy/power, SAR may also be thought of as being time dependent. That is, SAR may be thought of as a measure of energy accumulated at a particular point in space over a period of time. As also described above, the recent and more stringent regulatory requirements governing permissible SAR levels makes it difficult for wireless communications devices such as USB modems to be in compliance. Moreover, and in conventional devices, Tx antennas are selected solely based on performance criteria, such as, e.g., radio link quality, possibly resulting in only one of a plurality of Tx antennas being constantly utilized.

Because SAR involves a time aspect, constant RF signal transmission from a single Tx antenna may result in maximizing peak SAR readings/measurements. Hence, a conventional method of remaining in compliance with SAR requirements is simply to increase the physical size or footprint of a device to move a radiating element away from body tissue. Another known method is to add a large “halo” around a radiating element, such as a Tx antenna, to create a zone/barrier that keeps an end-user from being over-exposed to RF transmissions. However, enlarging devices is unappealing from a marketing standpoint as well as an end-user perspective, especially, when those devices are, e.g., stick-type USB modems. Not only is the trend to go smaller and smaller with electronic devices, but “new generation” devices would likely be larger that “previous generation” devices that had less stringent regulatory requirements to abide by. As noted previously, even when body tissue can be moved further away from a radiating source, regulatory requirements still exist when exposure may occur at distances of over 20 cm from body tissue, i.e., MPE limits. Like SAR, MPE may also be thought of as a time-averaged measurement, and like SAR, constant transmission from a single Tx antenna may result in increased MPE readings.

To address this maximizing of peak SAR/MPE readings, and in accordance with one embodiment of the present invention, the usage of multiple Tx antennas is coordinated such that no one Tx antenna is allowed to transmit enough time-averaged energy to violate the regulatory SAR/MPE limits. Because devices, such as USB modems, are able to track the amount of average energy per antenna that is being produced, a device may utilize this information to determine whether too much energy has been emitted from any given Tx antenna.

A software algorithm may be used to monitor an antenna's transmit power versus time. This monitored power-time data may then be used as an input parameter for the antenna selection process. For example, the power-time data may be used as an override to the conventional antenna selection criteria, such as the aforementioned link quality criteria. Hence, even if a first Tx antenna possessed the best link quality, if that first Tx antenna has been transmitting too much power for too long, a second Tx antenna would be selected for transmitting RF signals despite not having the best link quality.

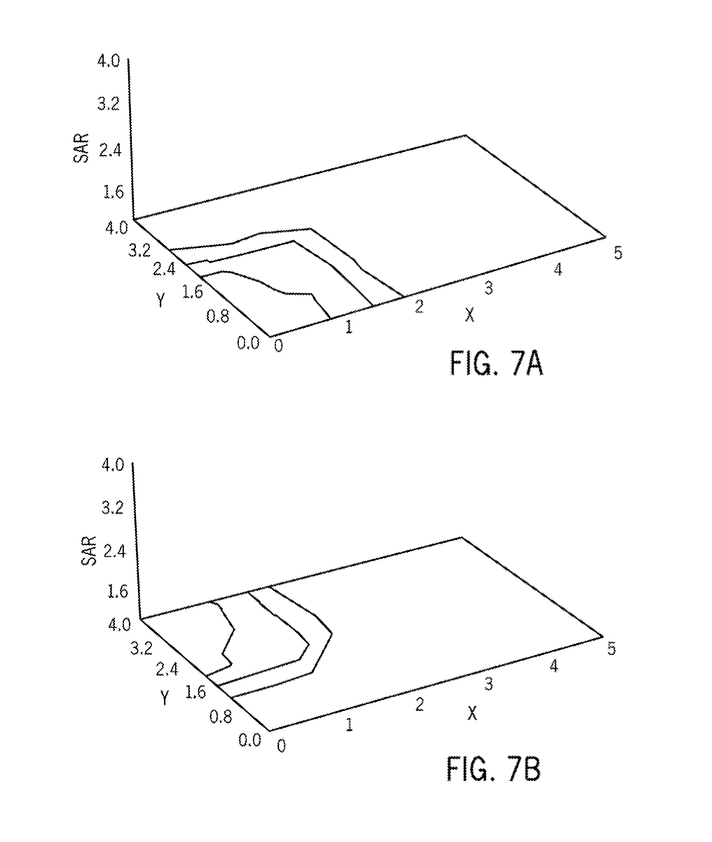

To achieve this overriding feature, the monitored power-time data may be compared to the time averaging requirements for SAR/MPE levels, which may be stored in a database/memory unit/suitable repository accessible in/by a device. FIG. 7A is a graph illustrating exemplary SAR measurements taken from a first Tx antenna after a relatively “long” transmission, where the SAR measurements are close to exceeding permissible SAR levels.

FIG. 7B is a graph illustrating exemplary SAR measurements taken at a second Tx antenna while the first Tx antenna is no longer active to allow that first Tx antenna to “cool off.” That is, the first Tx antenna would be prevented from transmitting RF signals until an average integrated power has decreased to acceptable SAR/MPE levels, at which point, the first and/or second Tx antenna(s) may be returned to the default or “normal” mode of operation. Alternatively, power level could be reduced while sharing transmit power between multiple Tx antennas. Hence, the actual selection of a Tx antenna may either be a hard selection, the result of a soft weighting method, etc.

It should be noted that the various embodiments of the present invention described herein and/or contemplated by the present invention may be combined in a plurality of different ways and still achieve the aforementioned features, including but not limited to the following. For example, both physical proximity and power-time data may be used as input parameters for the overriding of normal Tx antenna selection criteria. As another example, physical separation considerations may be taken into account along with device orientation when determining whether or not to allow a Tx antenna to transmit RF signals. As yet another example, all of device orientation, Tx antenna proximity, and time averaged energy considerations may be taken into account when controlling RF signal transmission in a wireless communications device.

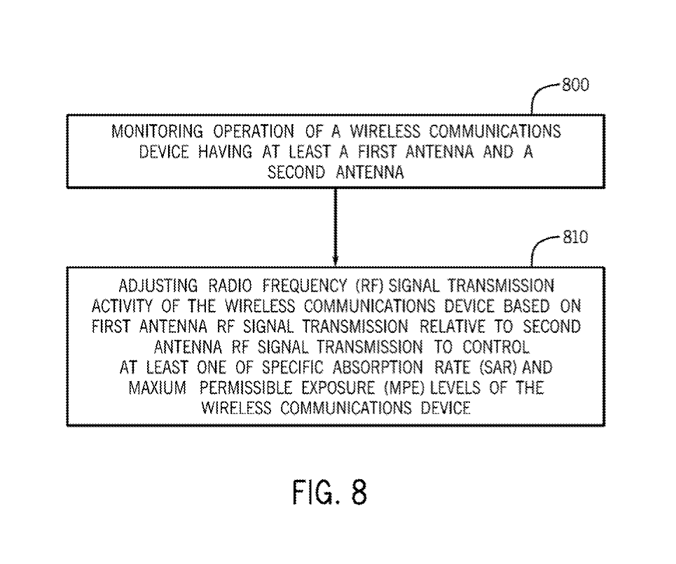

FIG. 8 is a flow chart illustrating exemplary processes performed in accordance with various embodiments of the present invention to achieve the reduction of SAR/MPE levels and/or the maintaining of acceptable SAR/MPE levels in wireless communications devices, such as USB modems. At 800, operation of a wireless communications device having at least a first antenna and a second antenna is monitored. At 810, radio frequency (RF) signal transmission activity of the wireless communications device is adjusted based on first antenna RF signal transmission relative to second antenna RF signal transmission to control at least one of SAR and MPE levels of the wireless communications device.

Various embodiments of the present invention may be implemented in a system having multiple communication devices that can communicate through one or more networks. The system may comprise any combination of wired or wireless networks such as a mobile telephone network, a wireless Local Area Network (LAN), a Bluetooth personal area network, an Ethernet LAN, a wide area network, the Internet, etc.

Communication devices may include a mobile telephone, a personal digital assistant (PDA), a notebook computer, etc. The communication devices may be located in a mode of transportation such as an automobile.

The communication devices may communicate using various transmission technologies such as Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

An electronic device in accordance with embodiments of the present invention may include a display, a keypad for input, a microphone, an ear-piece, a battery, and an antenna. The device may further include radio interface circuitry, codec circuitry, a controller/CPU/processor and a memory.

Various embodiments described herein are described in the general context of method steps or processes, which may be implemented in one embodiment by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various embodiments of the present invention can be accomplished with standard programming techniques with rule-based logic and other logic to accomplish various database searching steps or processes, correlation steps or processes, comparison steps or processes and decision steps or processes.

The foregoing description of various embodiments have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising:
monitoring operation of a wireless communications device having at least a first antenna and a second antenna; and
adjusting radio frequency (RF) signal transmission activity of the wireless communications device based on first antenna RF signal transmission relative to second antenna RF signal transmission to control at least one of specific absorption rate (SAR) and maximum permissible exposure (MPE) levels of the wireless communications device.

2. The method of claim 1, wherein the monitoring of the operation of the wireless communications device comprises determining an orientation of the wireless communications device relative to body tissue.

3. The method of claim 2, wherein the orientation of the wireless communications device relative to the body tissue is determined via an accelerometer.

4. The method of claim 2, wherein the adjusting of the RF signal transmission comprises prohibiting the first antenna RF signal transmission if the first antenna RF signal transmission will be directed towards the body tissue.

5. The method of claim 4 further comprising, allowing the second antenna RF signal transmission to occur provided that the second antenna RF signal transmission will not be directed towards the body tissue.

6. The method of claim 1, wherein the adjusting of the RF signal transmission activity comprises, if the first antenna RF signal transmission and the second antenna RF signal transmission is to occur simultaneously and the first antenna and the second antenna are in close proximity, overriding the second antenna RF signal transmission, the second antenna RF signal transmission being based on default selection criteria, and initiating third antenna RF signal transmission at a third antenna of the wireless communications device.

7. The method of claim 6, wherein the overriding of the second antenna RF signal transmission is further based upon transmit power level of a first radio associated with the first antenna, and transmit power level of a second radio associated with the second antenna and the third antenna.

8. The method of claim 1, wherein the monitoring of the operation of the wireless communications device comprises determining power level and transmission time of the first antenna RF signal transmission.

9. The method of claim 8, wherein the adjusting of the RF signal transmission comprises prohibiting further transmission of the first antenna RF signal transmission if the first antenna RF signal transmission surpasses time averaging requirements associated with the at least one of the SAR and MPE levels.

10. The method of claim 8, wherein the adjusting of the RF signal transmission comprises sharing further transmission of the first antenna RF signal transmission with the second antenna if the first antenna RF signal transmission surpasses time averaging requirements associated with the at least one of the SAR and MPE levels.

11. A computer-readable memory including computer executable instructions, the computer executable instructions, which when executed by a processor, cause an apparatus to perform a method as claimed in claim 1.

12. An apparatus, comprising:
at least one processor; and
at least one memory including computer program code, the at least one memory and the computer program code configured to, with the at least one processor, cause the apparatus to perform at least the following:
monitor operation of a wireless communications device having at least a first antenna and a second antenna; and
adjust radio frequency (RF) signal transmission activity of the wireless communications device based on first antenna RF signal transmission relative to second antenna RF signal transmission to control at least one of specific absorption rate (SAR) and maximum permissible exposure (MPE) levels of the wireless communications device.

13. The apparatus of claim 12, wherein to perform the monitoring of the operation of the wireless communications device, the at least one memory and the computer program code is configured to, with the at least one processor, cause the apparatus to determine an orientation of the wireless communications device relative to body tissue.

14. The apparatus of claim 13, wherein the apparatus further comprises an accelerometer configured to determine the orientation of the wireless communications device relative to the body tissue.

15. The apparatus of claim 13, wherein to perform the adjusting of the RF signal transmission, the at least one memory and the computer program code is configured to, with the at least one processor, cause the apparatus to prohibit the first antenna RF signal transmission if the first antenna RF signal transmission will be directed towards the body tissue.

16. The apparatus of claim 15, wherein the at least one memory and the computer program code is further configured to, with the at least one processor, cause the apparatus to allow the second antenna RF signal transmission to occur provided that the second antenna RF signal transmission will not be directed towards the body tissue.

17. The apparatus of claim 12, wherein to perform the adjusting of the RF signal transmission activity, the at least one memory and the computer program code is configured to, with the at least one processor, cause the apparatus to override the second antenna RF signal transmission, the second antenna RF signal transmission being based on default selection criteria, and initiate third antenna RF signal transmission at a third antenna of the wireless communications device, if the first antenna RF signal transmission and the second antenna RF signal transmission is to occur simultaneously and the first antenna and the second antenna are in close proximity.

18. The apparatus of claim 17, wherein the overriding of the second antenna RF signal transmission is further based upon transmit power level of a first radio associated with the first antenna, and transmit power level of a second radio associated with the second antenna and the third antenna.

19. The apparatus of claim 12, wherein to perform the monitoring of the operation of the wireless communications device, the at least one memory and the computer program code is configured to, with the at least one processor, cause the apparatus to determine power level and transmission time of the first antenna RF signal transmission.

20. The apparatus of claim 19, wherein to perform the adjusting of the RF signal transmission, the at least one memory and the computer program code is configured to, with the at least one processor, cause the apparatus to prohibit further transmission of the first antenna RF signal transmission if the first antenna RF signal transmission surpasses time averaging requirements associated with the at least one of the SAR and MPE levels.

21. The apparatus of claim 19, wherein to perform the adjusting of the RF signal transmission, the at least one memory and the computer program code is configured to, with the at least one processor, cause the apparatus to share further transmission of the first antenna RF signal transmission with the second antenna if the first antenna RF signal transmission surpasses time averaging requirements associated with the at least one of the SAR and MPE levels.
